(19) United States
(12) Patent Application Publication
(10) Pub. No.: US 2008/0077888 A1
(43) Pub. Date: Mar. 27, 2008

(54) CALENDAR APPLICATION USER INTERFACE WITH FREE-FORM APPOINTMENT ENTRY

(75) Inventor: Jan Thomas Miksovsky, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: COZI GROUP, INC., Seattle, WA (US)

(21) Appl. No.: 11/669,838

(22) Filed: Jan. 31, 2007

Related U.S. Application Data
(60) Provisional application No. 60/846,679, filed on Sep. 22, 2006.

(51) Int. Cl. G06F 3/048

(52) U.S. Cl. 715/963; 705/8

(57) ABSTRACT

A method and system is provided to dynamically update the calendar display as the user is typing a new appointment in the appointment entry area so that the user can see where the appointment will be added. In addition, the user can see where an appointment will be added by default if they fail to specify a specific date/time or date/time range in the appointment text, and can indicate a desired default date by pointing to the calendar display.

### CROSS-REFERENCE TO RELATED APPLICATION

This application claims the benefit of U.S. Provisional Application No. 60/846,679, filed Sep. 22, 2006.

### BACKGROUND

Many people employ software applications to maintain an appointment calendar. Typical examples of such applications are Microsoft Outlook® from Microsoft Corporation or Google Calendar® from Google. Such applications offer advantages over paper-based calendar systems, including the ability to vary the presentation of appointments or sets of appointments to suit the task at hand.

In such software applications, an appointment generally includes an appointment subject (a textual description of the event), as well as a start date/time and an end date/time. The calendar application usually includes a calendar display that can render the appointments occurring in a given date/time range.

The relationships between the abstract components of a calendar application are exemplified in FIG. 1. A calendar application user interface 100 includes an appointment entry interface 101 and a calendar display 102. Appointments entered by the user using the appointment entry interface 101 are recorded in a calendar database 103 residing in a storage medium (such as computer memory or disk storage). Appointments in the calendar database 103 are reflected in the calendar display 102.

In general, currently available calendar applications may include a calendar application user interface which can be categorized into two major modes for appointment entry:
1. Using the keyboard or pointing device to invoke a “new appointment” command. This produces an appointment entry form that the user fills in with details such as the appointment subject, start date/time, and end date/time. When the user finishes editing the appointment entry form, the new appointment is stored in the calendar database 103 and thereby reflected in the calendar display 102.
2. Using the pointing device, the user indicates a date/time range in the calendar display 102 (e.g., by clicking the mouse button down on the start date/time, then dragging and releasing the mouse on the end date/time), then begins typing. A new appointment is created with the selected start and end dates/times and the supplied text as the subject. When the user indicates that they are finished (e.g., by pressing the Enter key), the typed appointment is added to the calendar database 103 and the calendar display 102 is updated accordingly. If, before finishing, the user cancels the operation (e.g., presses the Escape key), the new appointment is discarded and not added to the database.

To simplify the creation of appointments, some other calendar applications provide a different calendar application user interface allowing a user to enter an appointment in a free-form appointment entry. Such an interface may comprise an appointment entry area (an instance of an appointment entry interface 101) and a calendar display (an instance of a calendar display 102).

For example, after a user enters a text description of an appointment into the appointment entry area of a calendar application, the text description will be parsed and detailed information relevant to the appointment may be extracted from the parsed text description. The calendar application uses the detailed information to store the appointment in the calendar database 103. Consequently, based on the stored appointment in the calendar database, the calendar display renders the details on the calendar display for a given time period. However, observations and accounts of users employing a calendar application user interface with free-form appointment entry have identified deficiencies with such an interface, including:
1. The calendar display does not allow users to select a specific date/time or date/time range and then have the text entered in the appointment entry area cause an appointment to be created at the indicated date/time or date/time range.
2. The calendar application user interface does not allow users to indicate a day in the calendar display (e.g., by clicking on it) and then enter text in the appointment entry area. If, in this case, users supply a start time (or start time and end time) but omit the day from the appointment text, the appointment will not be added with the given start time (and end time) on the day the users first indicated (clicked).
3. The application may make mistakes parsing the appointment text, but the users will not be able to recognize the mistakes until they finish entering the appointment and the application updates the calendar display to reflect its understanding (or misunderstanding) of the appointment details.
4. A user typing an appointment in the appointment entry area cannot see on the calendar display if the new appointment will conflict with existing appointments on the calendar (or other date-related commitments such as a weekend or holiday) until the appointment has already been added to the calendar.

Accordingly, there exists a need for a new improved calendar application user interface.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Generally described, a method and system are disclosed for assisting a user to create or manage an appointment by determining and displaying proposed date information. More specifically, the method and system dynamically update a calendar display as a user is typing a new appointment in an appointment entry area so that the user can see where the appointment will be added. In addition, the method and system allow a user to see where an appointment will be added by default if they fail to specify a specific date/time or date/time range in the appointment text.

In accordance with an aspect of the present invention, a method for creating an appointment in response to free-form user input is provided. The method includes determining a default date for an appointment, displaying the determined default date as an appointment date, and receiving an appointment description in a free-form format. The appointment description is parsed to obtain date information while the appointment description is received and a date corresponding to the obtained date information may be displayed as the appointment date. The default date is used for an appointment when the appointment description does not include the date information. The appointment is created in accordance with the appointment description.

In an aspect of the method, a user is provided with the ability to use the appointment entry area as a means of navigating the calendar display. If the user enters an appointment description which only includes a specified date, a calendar display corresponding to the specified date is displayed.

In accordance with another aspect of the present invention, a calendar application system for displaying a potential appointment date for a user to create an appointment is provided. The calendar application system includes a user interface component, a processing component, and display component. The user interface component receives a user input including an appointment text from a user where the appointment text is received in a free form format. The processing component determines a potential appointment date which is updated based on the user's indication such as by specifying a date, removing date information, etc. In addition, the processing component extracts date information from the appointment text to determine the potential appointment date. The determined potential appointment date is displayed within a calendar display such that the user can recognize the potential appointment date before completing the appointment text.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram illustrative of the abstract relationships between components in a calendar software application;

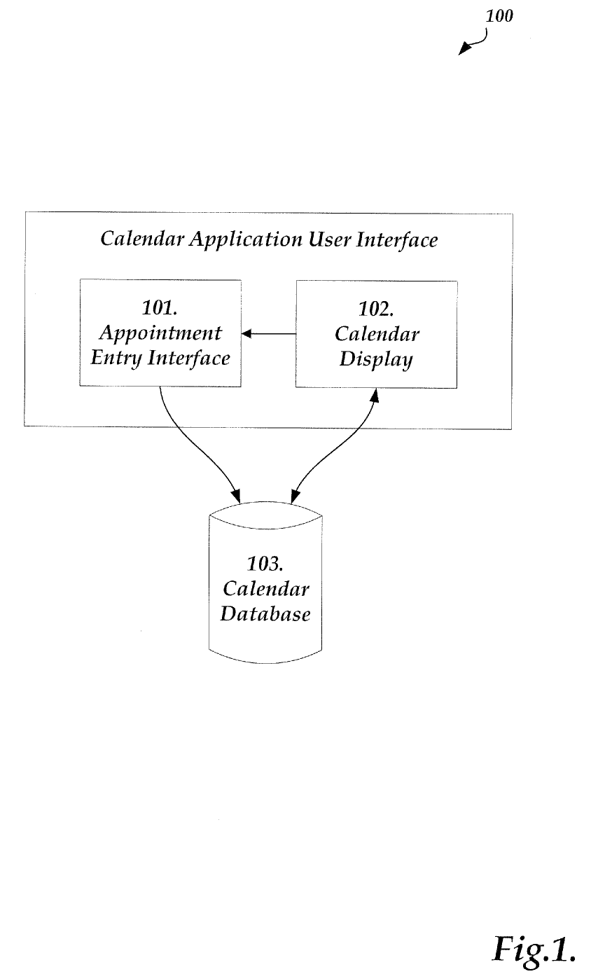

FIG. 2 is a flow diagram illustrative of a calendar interaction routine implemented in accordance with an embodiment of the present invention;

FIG. 3 is a pictorial diagram illustrative of an exemplary screen that includes a calendar display and an appointment entry area in accordance with an embodiment of the present invention;

FIG. 4 is a pictorial diagram illustrative of an exemplary screen after the user specifies an appointment date on the calendar display in accordance with an embodiment of the present invention;

FIG. 5 is a pictorial diagram illustrative of an exemplary screen after the user has entered an appointment text to create an appointment in accordance with an embodiment of the present invention; and

FIG. 6 is a pictorial diagram illustrative of an exemplary screen displayed in accordance with an embodiment of the present invention after a new appointment is created in the calendar database.

### DETAILED DESCRIPTION

The present application is directed to a method and system for assisting a user to create or manage an appointment by determining and displaying proposed date information. More specifically, the present application is directed to a method and system for determining and displaying an “appointment date” to which a new appointment will be added. An “appointment date,” as used herein, refers to a date that is to be used for an appointment. The appointment date is generally determined based on a user-specified date. Further, in order to assist a user to create an appointment, a “default date,” i.e., a proposed date that is to be used for a new appointment unless the user indicates otherwise is displayed as an appointment date. In an embodiment, a calendar display is dynamically updated to display an appointment date as the user is typing a new appointment in a free format. In this manner, the user is visually informed where the new appointment will be added in the calendar display.

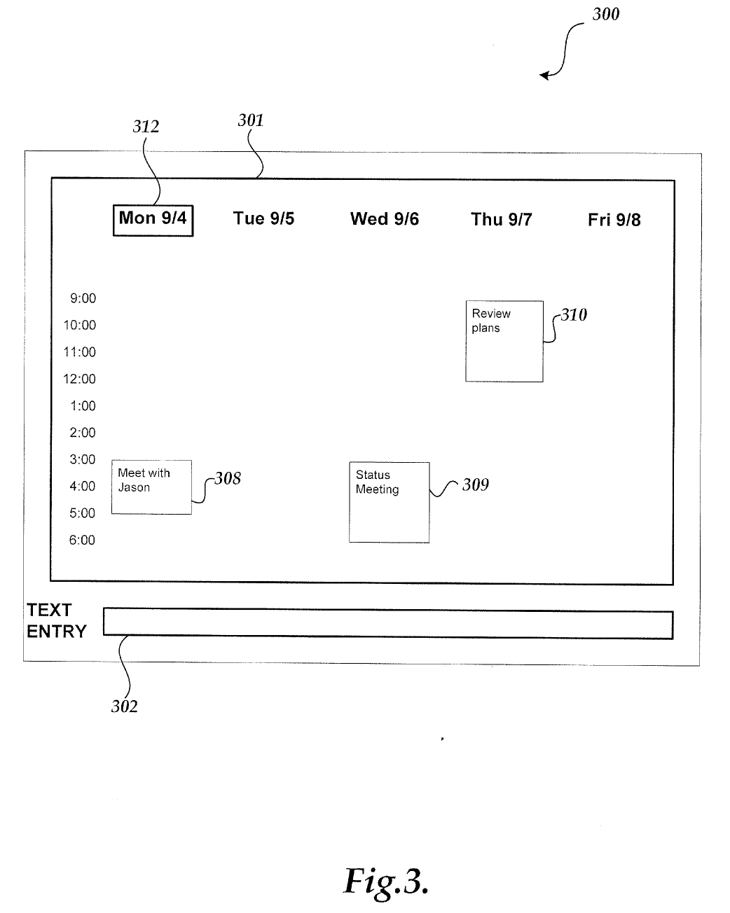

Referring to FIG. 3, an exemplary screen 300 of a calendar application system is depicted in accordance with an embodiment of the present invention. The exemplary screen 300 may include a calendar display 301 that renders the appointments occurring in a given date/time range. The exemplary screen 300 also includes an appointment entry area 302 where a user enters text description of an appointment (appointment text) in a free format. The user can specify a date for an appointment via interaction on the calendar display 301 or can enter a text description in the appointment entry area 302. Further, the user can use the combination of the appointment entry area 302 and the calendar display 301 to create an appointment in a variety of ways. Once an appointment is created, the appointment 308-310 is displayed on the calendar display 301, generally including an appointment subject extracted from the appointment text.

As shown in FIG. 3, when the calendar application system is launched, the exemplary screen 300 displays the calendar display 301 with the default date having an initial date value which has been previously defined. Although any initial value can be defined, the initial value for the default date is preferably a current date. The default date may be used for a new appointment unless the user indicates otherwise. As will be discussed in greater detail below, the default date may change based upon a user's input. For example, if the user specifies a date on the calendar display (e.g., clicks on a date with a pointing device), the specified date may become the default date. For another example, if the user creates a new appointment, the start date of the new appointment may become the default date.

Typically, the calendar display 301 within the exemplary screen 300 shows a range of dates/times such as a week, 5 working days, etc. Thus, when a user adjusts the calendar display 301 to show a new date/time range shown on the calendar display 301, the default date may be outside of the new date/time range and no portion of the default date may be visible on the calendar display 301. In this case, the calendar application may preliminarily identify a new default date within the range of currently visible dates within the exemplary screen. In one embodiment, the new default date may be a date within the new date/time range, which is closest to the previous default date. In this manner, at least a portion of the default date may be always visible in the calendar display 301. However, it is to be understood that any suitable way to preliminarily identify a new default date may be used.

In a preferred embodiment, a date which is proposed or determined as an appointment date may be visually distinguished in the calendar display such that the user can be informed about where new appointments will end up unless the user indicates otherwise. As shown in FIG. 3, the default date (09/04) is proposed as an appointment date, which is visually distinguished by use of the date indicator 312. The date indicator 312 may be an icon, a box around a date, or the like. In addition, the proposed or determined appointment date can be visually distinguished by highlighting, using different fonts, different colors, etc.

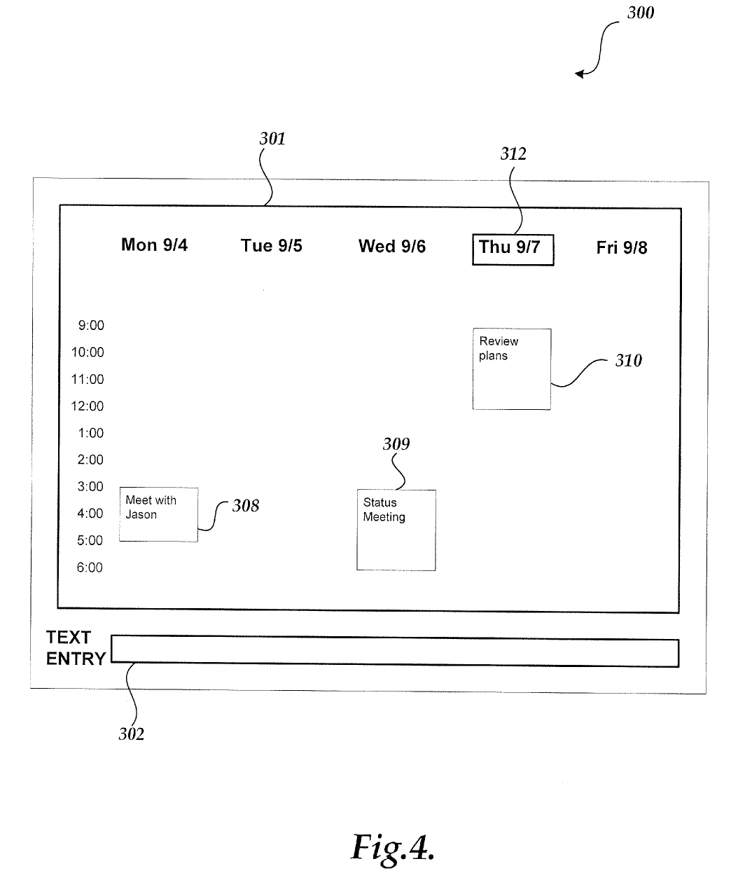

Referring to FIG. 4, an exemplary screen 400 depicts the calendar display after the user specifies a date on the calendar display (e.g., clicks on a date with a pointing device). As mentioned above, the user can specify a date for an appointment via interaction on the calendar display 301 or entering a text description in the appointment entry area 302. If the user has specified a date via interaction on the calendar display (e.g., by clicking on the calendar display, etc.), the user-specified date is presumably a date for an appointment. The user-specified date may be displayed as an appointment date. For example, if the user selects a specific date (09/07) on the calendar display 301, the specified date (09/07) may be visually distinguished by the date indicator 312 such that the user can recognize that the specified date (09/07) is to be an appointment date. One skilled in the art will understand that the use of a date indicator 312 could also be extended to support the indication of a selected time or time range. After the user's input, the default date becomes the specified date.

Likewise, if the user has instead specified a date in the appointment text entered in the appointment entry area 302, the date specified in the appointment text may be displayed as the appointment date. As the user edits the appointment text in the appointment entry area 302, the calendar application system updates the calendar display 301 such that at least a portion of the specified date is visible. This allows the users to see where the new appointment will be added before they actually create the appointment in the calendar application system. The date indicator 312 is moved to indicate that the specified date is to be the appointment date. The user can thereby directly confirm that the specified date is in fact an appropriate date for the appointment the user is entering. The user can edit the appointment text to specify a new date if the appointment date displayed in the calendar display 301 is not desirable. In an alternative embodiment, the calendar application system dynamically updates a calendar display 301 as a user is typing an appointment text in an appointment entry area so that the user can see the appointment text displayed on the calendar display 301.

It should be noted that, if the user begins entering an appointment text in the appointment entry area 302 and specifies a date within the appointment text then the user either removes the date from the appointment text or cancels the creation of the appointment, the date indicator may move back to the previously displayed appointment date (e.g., previously determined default date, previously specified date, etc.). This ensures that any changes to the calendar display 301 during editing are also effectively undone in accordance with the appointment text in the appointment entry area 302. Further, it is to be understood that the user can cancel the addition of the appointment anytime during editing or entering the appointment text (for example, by pressing the Escape key). Upon receipt of a canceling indication, the calendar appointment system will set the appointment entry area 302 to be ready to receive a new appointment and update the default date if necessary so that the user can start entering a new appointment description.

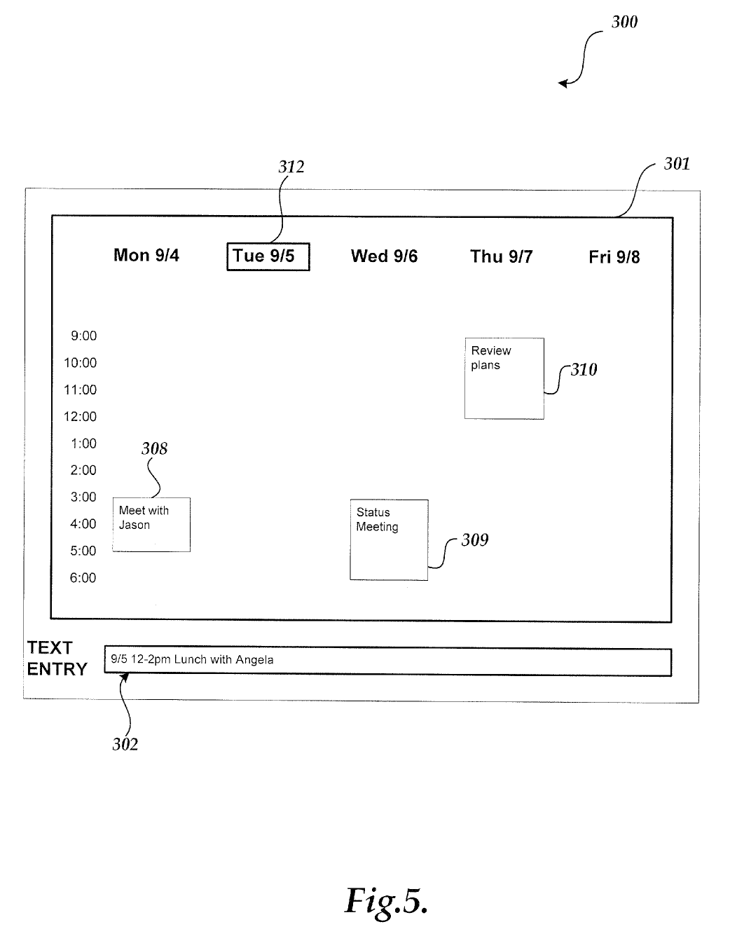

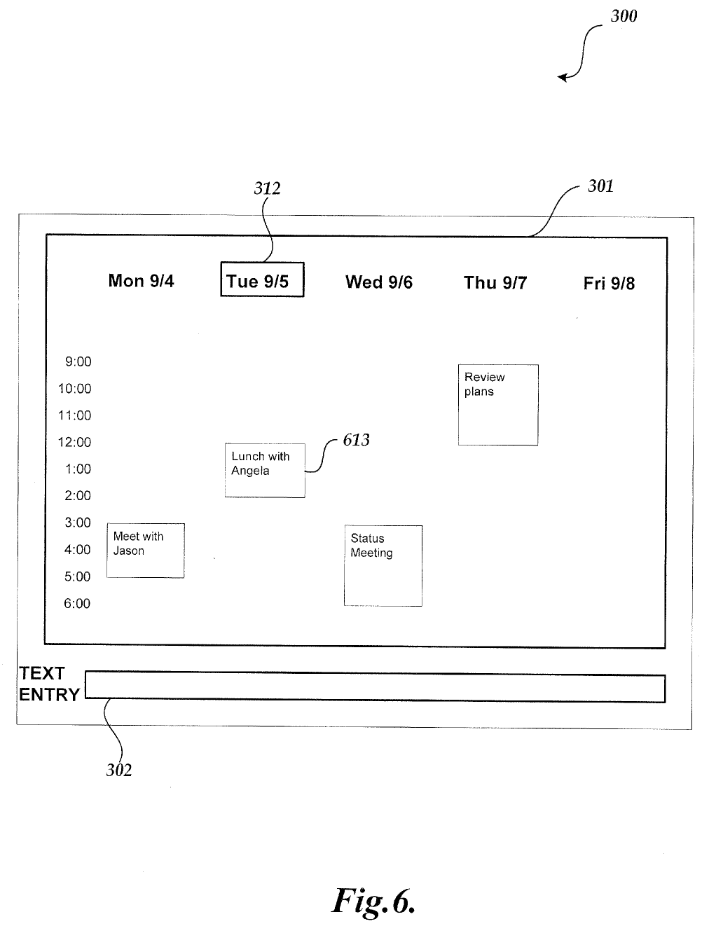

Referring now to FIG. 5, an exemplary screen 500 shows the result of the user specifying a date in the appointment text “9/5 12-2 pm lunch with Angela” entered into the appointment entry area 302. The user-specified date is extracted from the appointment text. As shown in FIG. 5, the user-specified date is displayed as an appointment date via the date indicator 312. In this manner, the user can easily recognize that the visually distinguished date is to be used for the appointment which the user is entering in the appointment entry area 302. After the user creates a new appointment, the calendar display 301 is updated to reflect the created new appointment, such as the new appointment 613 in FIG. 6. As shown, the new appointment 613 includes an appointment subject “lunch with Angela” which was extracted from the appointment text “9/5 12-2 pm lunch with Angela.” Subsequently, the appointment entry area 202 may be cleared to receive a new appointment text.

In one embodiment, the user can use the appointment entry area 302 just to specify a date on the calendar display 301. As the user is typing date information in the appointment entry area 302, the user can see the calendar display 301 updating to show with which date the new appointment will go. For example, if the user enters an appointment text including date information without any other details related to the appointment in the appointment entry area 302, the calendar display 301 displays the specified date as the appointment date. The specified date also becomes the default date for the next appointment and the appointment entry area 302 is cleared to receive a new appointment text.

If the specified date is not within a current date/time range of the calendar display 301, the calendar display 301 is updated to display at least a portion of the specified date as an appointment date. In this manner, the user can navigate the calendar display. In addition, the user can first specify a date for an appointment in the appointment entry area 302 and then enter other details related to the appointment in the appointment entry area 302. For example, typing “2/14 Valentine's Day” in the appointment entry area 302 and pressing the “Enter” key has the exact same effect as typing “2/14” in the appointment entry area 302, pressing the “Enter” key, typing “Valentine's Day” in the appointment entry area 302, and then pressing the “Enter” key again.

In one embodiment, the user can use the combination of the appointment entry area 302 and the calendar display 301 to create an appointment in a variety of ways. For example, at any point, the user can type an appointment text without specifying any dates and have the appointment added to the default date. Further, the user can specify a date in the calendar display 301, then type an appointment text in the appointment entry area 302 without any date/time information and complete the appointment (indicate to finish entering the appointment text) to have it added to the specified date.

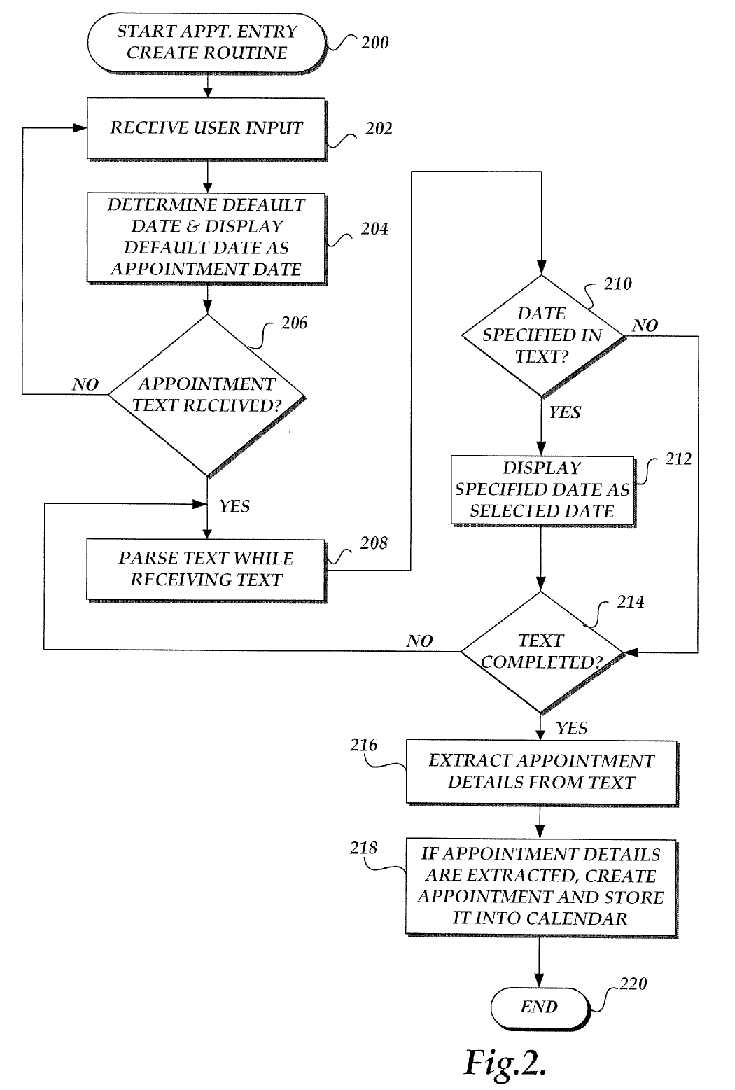

Referring now to FIG. 2, a flow diagram 200 depicts a calendar interaction routine 200 implemented in accordance with embodiments of the present invention. The routine 200 governs the interaction of the default date and appointment date as the user edits text in the appointment entry area 302.

When a user first starts the calendar application or starts entering a new appointment, the appointment entry area 302 may be at an initial state containing no text. For the purpose of discussion, assume that a default date is a current date and the default date is initially displayed as an appointment date via the date indicator 312 or other visual indicator within a calendar display 310.

At block 202, user input is received. For example, the user can select a date or a range of times on the calendar display 310 or the user begins entering an appointment text in the appointment entry area 302. The user can also edit the appointment text by adding characters to the appointment text, removing characters, etc. At block 204, based on the user input, the default date may be updated and the calendar display may be updated to display, via the date indicator 312, the updated default date as an appointment date. At decision block 206 a determination is made as to whether the user input is an appointment text. If it is determined that an appointment text is received as the user input, at block 208 the current appointment text in the appointment entry area 302 is parsed to extract, if present, a start date/time. One skilled in the art will recognize a variety of techniques by which such parsing can take place. The appointment text in the appointment entry area 302 may be dynamically parsed while the appointment text is being received. It is to be understood that the user can specify a date in a variety of formats including, but not limited to, conventional date formats (“June 2,” “12/25/07,” etc.), as well as natural language words or phrases that refer to dates (“tomorrow,” “next Saturday,” etc.).

At decision block 210, a determination is made as to whether the user has specified a date for the appointment in the appointment text. If the user has specified a date for an appointment in the appointment text, the user-specified date in the appointment text is displayed as the appointment date as illustrated at block 212. In an embodiment, when the user specifies a date, the calendar display 301 may change the current date/time range in order to make the specified date visible in the calendar display 301. If possible, the entire specified date is made visible; if the calendar display 301 cannot render the entirety of the specified date, then at least a portion of the specified date is made visible. (If the user has supplied a start time for the appointment, then the selected start time falls within the portion of the start date which is made visible.) Furthermore, the date indicator 312 is moved to indicate that the specified date is to be the appointment date. The user can thereby directly verify the accuracy of the parsing, as well as confirm that the specified date is in fact an appropriate date for the appointment the user is entering. The user can specify a new date if the appointment date displayed in the calendar display 301 is not desirable.

At decision block 214, a determination is made as to whether the user finishes entering the appointment text and is ready to create the new appointment in the calendar (for example, they have pressed an “Enter” key). The user can edit the appointment text until the desired date is displayed as an appointment date in the calendar display. If the user is satisfied with the displayed date for the appointment date, the user finishes entering the appointment text. Then, the appointment is created for the date displayed as an appointment date. In some instances, although the user enters date information in the appointment text, the entered date information may not represent the desired appointment date. For example, when a user enters an appointment text such as “meet Sara to prepare a meeting report for tomorrow,” the calendar application may extract “tomorrow” for a specified date for the appointment description and the date corresponding to “tomorrow” may be displayed as an appointment date. The user can correct this by removing “for tomorrow” and then adding “today” in the text. As a result, “today” is extracted and the date corresponding to “today” may be displayed as an appointment date.

If it is determined that the user has not finished entering the appointment text in the appointment entry area 302, the routine 200 returns to block 208, allowing the user to continue entering the appointment text in the appointment entry area 302. If it is determined that the user has finished entering the appointment text, at block 216 other details about the appointment such as the appointment subject are extracted from the entered appointment text. Once the appointment details other than date information are extracted, at block 218, a new appointment may be created with those details and stored to the calendar database 103 along with the appointment date information. The routine 200 completes at block 220.

One skilled in the art will recognize that the aforementioned embodiments are described for illustrative purpose only, and thus, are not to be construed as limiting. Moreover, although specific screen displays and an exemplary flow diagram of a calendar interaction routine are illustrated, it should be understood that the examples provided are not exhaustive and do not limit the present application. For example, when the calendar application identifies a user-specified date in conjunction with a default date, any suitable order of steps for identifying the user-specified date or the default date can be implemented.

It is contemplated that any alternate forms of specifying appointment text without, or in addition to, a keyboard may be implemented. For example, a computer speech recognition system may be utilized for an alternate form of specifying text. Such a system could allow the user to specify appointment text. The recognized text could be rendered in a visible appointment entry text area 302, or it could be hidden from the user. In either case, the calendar display 301 could be updated as the user specifies text in the manner described in FIG. 2. This would allow the user to verify that an appointment will be created with the desired start/end date/times before they have committed the appointment to the calendar.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for creating an appointment in a calendar display in response to free-form user input, the method comprising:
determining a default date for an appointment and displaying the determined default date as an appointment date;
receiving an appointment description in a free-form format;
while receiving an appointment description, parsing the appointment description to extract date information;
upon extracting the date information, displaying a date corresponding to the date information as the appointment date;
detecting user indication of completing the appointment description and identifying a date which is currently displayed as the appointment date;
upon detection of user indication of completing the appointment description, creating an appointment in accordance with the appointment description, the appointment being associated with the identified date.

2. The method of claim 1 wherein creating an appointment includes parsing the appointment description to extract content of the appointment.

3. The method of claim 2 wherein if no content of the appointment is extracted, no appointment is created.

4. The method of claim 1 wherein the appointment date is visually distinguished on the calendar display.

5. The method of claim 1 wherein if the date information in the appointment description is updated by the user, extracting the updated date information in the appointment description and displaying a date corresponding to the extracted updated date information as the appointment date.

6. The method of claim 1, further comprising:
displaying the created appointment within a calendar display.

7. The method of claim 1 wherein the default date is a date selected by the user from a calendar.

8. The method of claim 1 wherein the default date is a current date.

9. The method of claim 1 wherein the default date is updated as the date information extracted from the appointment description.

10. A calendar application system for displaying a potential appointment date for a user to create an appointment, the calendar application system comprising:
a user interface component for receiving a user input on a calendar display, the user input including an appointment text from a user wherein the appointment text is received in a free form format;
a processing component for determining a potential appointment date which is updated based on the user's indication;
a display component for displaying the determined potential appointment date;
wherein the processing component extracts date information from the appointment text and the display component displays a date corresponding to the extracted date information as the potential appointment date.

11. The calendar application system of claim 10 wherein the user interface component for receiving a user input indicating to complete the appointment text and the processing component extracts content of the appointment from the completed appointment text.

12. The calendar application system of claim 11, further comprising:
after the content of the appointment is extracted, creating an appointment with the extracted content.

13. The calendar application system of claim 12 wherein the appointment is stored for the potential appointment date in a calendar database.

14. The calendar application system of claim 13 wherein the processing component determines a default date which is used as the potential appointment date if the date information is not extracted from the text.

15. The calendar application system of claim 13 wherein the user indicates to navigate the calendar display by specifying date information in the appointment text without content.

16. The calendar application system of claim 13 wherein the user input is voice information describing an appointment and the user input is converted to an appointment text representing the voice information.

17. A method for determining a proposed date for an appointment when a user enters an appointment description, the method comprising:
determining a default date for the proposed date and displaying the default date as the proposed date which is visibly distinguished within a calendar display;
detecting a user indication specifying a date to change the proposed date; and
upon detection of the user indication, determining a specified date for the proposed date and display the specified date as the proposed date which is visibly distinguished within a calendar display;
wherein at least one of the determined default date or the determined specified date is used for creating an appointment.

18. The method of claim 18 wherein the user indication is selecting a date from the calendar display.

19. The method of claim 18 wherein the user indication is entering date information as part of the appointment description.

20. The method of claim 19 wherein the calendar display is dynamically updated as the date information is entered as part of the appointment description.
